(19) United States
(12) Patent Application Publication
(10) Pub. No.: US 2026/0103154 A1
(43) Pub. Date: Apr. 16, 2026

(54) COMMUNICATION SYSTEM

(71) Applicant: DENSO CORPORATION, Kariya-city (JP)

(72) Inventors: Yukihiro YAMAKAWA, Kariya-city (JP); Tomohisa KISHIGAMI, Kariya-city (JP)

(21) Appl. No.: 19/353,657

(22) Filed: Oct. 9, 2025

(30) Foreign Application Priority Data
Oct. 11, 2024 (JP) 2024-178897

(51) Int. Cl. B60R 16/023; G07C 5/08

(52) U.S. Cl. CPC B60R 16/0232; B60R 16/0238; G07C 5/0816

(57) ABSTRACT

A communication system mounted on a vehicle includes one or more first ECUs each being connected to one or more terminal devices and a second ECU communicably connected to the first ECUs. The terminal devices and the first ECUs are supplied with power from a power source. The second ECU controls power supply to the one or more terminal devices and/or the first ECUs. The first ECU is configured to: detect an interruption of communication between the one or more first electronic control units and the second electronic control unit; specify a vehicle situation indicating an operation state of the vehicle based on vehicle information, which is information obtained from an in-vehicle device, in response to detecting the interruption of communication; and control the state of power supply to the one or more terminal devices according to the specified vehicle situation.

### CROSS REFERENCE TO RELATED APPLICATION

The present application claims the benefit of priority from Japanese Patent Application No. 2024-178897 filed on October 11, 2024. The entire disclosure of the above application is incorporated herein by reference.

### TECHNICAL FIELD

The present disclosure relates to a technique of a communication system capable of controlling power supply.

### BACKGROUND

There has been known an in-vehicle network system that includes a power supply relay. The power supply relay individually switches ON state and OFF state of power supply to each electronic control unit. In this kind of in-vehicle network system, a control content of turning on or turning off a power supply to a predetermined electronic control unit corresponding to a specified scene is determined based on a situation of vehicle, and the power supply to a predetermined electronic control unit is turned on or turned off using the power supply relay based on the determined control content.

### SUMMARY

According to an aspect of the present disclosure, a communication system mounted on a vehicle includes one or more first electronic control units and a second electronic control unit. The one or more first electronic control units each is connected to one or more terminal devices and is configured to control an operation of each terminal device. The second electronic control unit is communicably connected to the one or more first electronic control units and configured to control an operation of each first electronic control unit. The one or more terminal devices and the one or more first electronic control units are supplied with power from a power source. A state of power supply to the one or more terminal devices and/or the one or more first electronic control units is configured to be controlled based on an instruction from the second electronic control unit. The first electronic control unit includes at least one processor with a memory storing computer program, wherein the at least one processor with the memory may be configured to cause the first electronic control unit to: detect an interruption of communication between the one or more first electronic control units and the second electronic control unit; specify a vehicle situation indicating an operation state of the vehicle based on vehicle information, which is information obtained from an in-vehicle device, in response to detecting the interruption of communication; and control the state of power supply to the one or more terminal devices according to the specified vehicle situation.

### BRIEF DESCRIPTION OF DRAWINGS

Features of the present disclosure will become apparent from the following detailed description made with reference to the accompanying drawings. In the drawings:

FIG. 1 is a block diagram illustrating an overall configuration of a communication system according to a first embodiment;

FIG. 2A is a block diagram illustrating an outline of a hardware configuration of a mobility computer;

FIG. 2B is a block diagram illustrating an outline of a hardware configuration of a zone ECU;

FIG. 2C is a block diagram illustrating an outline of a hardware configuration of a terminal ECU;

FIG. 3A is a diagram illustrating a change in a vehicle situation;

FIG. 3B is a diagram of an activation ECU in a functional unit according to the vehicle situation;

FIG. 4A is a diagram illustrating an activation ECU for each functional unit in communication and power supply cooperation control;

FIG. 4B is a diagram illustrating a method for activating an ECU;

FIG. 5 is a block diagram functionally illustrating the zone ECU;

FIG. 6 is a sequence diagram illustrating a procedure when shifting from parking to riding;

FIG. 7 is a sequence diagram illustrating a procedure when shifting from riding to parking;

FIG. 8 is a diagram illustrating a procedure when communication is interrupted;

FIG. 9 is a diagram illustrating the change in the vehicle situation and a change in an energization state to an electric device;

FIG. 10 is a sequence diagram illustrating a procedure performed in the communication system when the communication is interrupted;

FIG. 11 is a flowchart illustrating main processing performed in the communication system when the communication is interrupted; and

FIG. 12 is a block diagram illustrating an overall configuration of a communication system according to a second embodiment.

### DESCRIPTION OF EMBODIMENTS

There has been known an in-vehicle network system including an integrated electronic control unit having a power distribution control function. After performing a detailed study on this kind of in-vehicle network system by the inventors of the present application, when a communication interruption between an electronic control unit (for example, a zone ECU) under the control of the integrated electronic control unit and a terminal device such as an ECU connected to the zone ECU, that is, the communication interruption is occurred between the integrated electronic control unit and the zone ECU, the countermeasure for this kind of communication interruption is not provided in detail.

For example, in a system in which the integrated electronic control unit controls the power distribution of the terminal device via the zone ECU, when the communication between the integrated electronic control unit and the zone ECU is interrupted, the system may fail to provide proper power distribution control to the terminal device.

According to an aspect of the present disclosure, a communication system mounted on a vehicle includes one or more first electronic control units and a second electronic control unit. The one or more first electronic control units each is connected to one or more terminal devices and is configured to control an operation of each terminal device. The second electronic control unit is communicably connected to the one or more first electronic control units and configured to control an operation of each first electronic control unit. The one or more terminal devices and the one or more first electronic control units are supplied with power from a power source. A state of power supply to the one or more terminal devices and/or the one or more first electronic control units is configured to be controlled based on an instruction from the second electronic control unit. The first electronic control unit includes an interruption detection unit, a situation grasping unit, and a power control unit. The interruption detection unit is configured to detect an interruption of communication between the one or more first electronic control units and the second electronic control unit. The situation grasping unit is configured to specify a vehicle situation indicating an operation state of the vehicle based on vehicle information, which is information obtained from an in-vehicle device, in response to detecting the interruption of communication. The power control unit is configured to control the state of power supply to the one or more terminal devices according to the specified vehicle situation.

With the above configuration of the present disclosure, even when a failure occurs in communication between the electronic control unit (for example, the second electronic control unit) that issues an instruction for controlling the supply state of power (that is, an instruction for power distribution control) and the electronic control unit (for example, the first electronic control unit) that receives the instruction, it is possible to reduce an adverse effect on an operation of a vehicle (for example, an adverse effect on control of vehicle). Thus, a fail-safe is provided when a failure occurs in the communication between the electronic control unit that issues the instruction for power distribution control and the electronic control unit that receives the instruction in the communication system.

In the above configuration, when an interruption of communication between the first electronic control unit and the second electronic control unit is detected, the first electronic control unit controls the state of power supply to the terminal device according to the vehicle situation. Therefore, even when the communication between the first electronic control unit and the second electronic control unit is interrupted, the first electronic control unit can appropriately control the state of power supply to the terminal device according to the vehicle situation. Therefore, vehicle safety can be improved when the vehicle is in operating state (that is, a proper fail-safe can be provided).

Hereinafter, exemplary embodiments of the present disclosure will be described with reference to the drawings.

### 1. First Embodiment

### 1-1. Overall Configuration

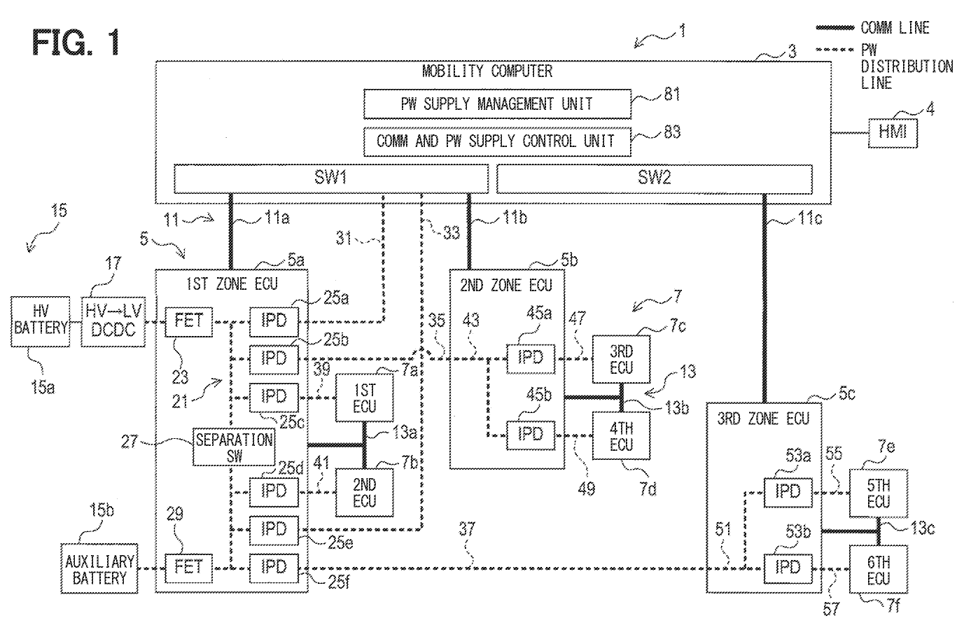

As illustrated in FIG. 1, a communication system 1 according to a first embodiment is a system mounted on a vehicle such as an automobile.

The communication system 1 according to the first embodiment is based on a well-known zone architecture, and uses multiple electronic control units disposed according to sections such as zones, which are multiple areas (that is, arrangement locations in the vehicle).

The communication system 1 includes, as electronic control units, a mobility computer 3 (hereinafter referred to as a mobility computer), multiple zone ECUs 5 communicably connected to the mobility computer 3, and multiple terminal ECUs 7 communicably connected to the zone ECUs 5. The terminal ECU 7 may be simply referred to as ECU 7. ECU is an abbreviation for Electronic Control Unit.

Examples of the multiple zone ECUs 5 include a first zone ECU 5a, a second zone ECU 5b, and a third zone ECU 5c. Examples of the multiple terminal ECUs 7 include a first terminal ECU 7a and a second terminal ECU 7b communicably connected to the first zone ECU 5a, a third terminal ECU 7c and a fourth terminal ECU 7d communicably connected to the second zone ECU 5b, and a fifth terminal ECU 7e and a sixth terminal ECU 7f communicably connected to the third zone ECU 5c.

The mobility computer 3 is a control unit capable of controlling each zone ECU 5 communicably connected to the mobility computer 3, that is, a management control unit that issues an instruction such as control of power to an electric device such as the subordinate zone ECU 5 or the terminal ECU 7 (that is, issues an instruction such as power distribution control). The mobility computer 3 and each zone ECU 5 are communicably connected to each other by a main communication line 11. The main communication line 11 is, for example, a communication line capable of performing communication by Ethernet (registered trademark). Communication by a CAN may be possible. CAN is an abbreviation for Controller Area Network. In the drawings, communication line is indicated as COMM LINE.

An HMI 4 is communicably connected to the mobility computer 3. Examples of the HMI 4 include an input device (for example, a touch panel) capable of inputting by a person, a display device (for example, a display) for notifying a person, and a speaker. The HMI is an abbreviation for Human Machine Interface.

Examples of the main communication line 11 include a first main communication line 11a that connects the mobility computer 3 and the first zone ECU 5a via an Ethernet switch SW1, a second main communication line 11b that connects the mobility computer 3 and the second zone ECU 5b via the Ethernet switch SW1, and a third main communication line 11c that connects the mobility computer 3 and the third zone ECU 5c via an Ethernet switch SW2.

Each zone ECU 5 is a control unit capable of controlling the terminal ECU 7 connected to the zone ECU 5. Each zone ECU 5 and each terminal ECU 7 are communicably connected to each other by a terminal communication line 13. The terminal communication line 13 is, for example, a communication line capable of performing communication by the CAN. Communication by Ethernet may be possible.

Examples of the terminal communication line 13 include a first terminal communication line 13a that communicably connects the first zone ECU 5a to the first terminal ECU 7a and the second terminal ECU 7b, a second terminal communication line 13b that communicably connects the second zone ECU 5b to the third terminal ECU 7c and the fourth terminal ECU 7d, and a third terminal communication line 13c that communicably connects the third zone ECU 5c to the fifth terminal ECU 7e and the sixth terminal ECU 7f.

Although not illustrated, an electronic device such as a sensor may be connected to each zone ECU 5 via a direct line. In such a case, various types of information (that is, vehicle information obtained from various in-vehicle devices) that can be used when a situation of the vehicle (that is, a vehicle situation) is grasped can be acquired from the electronic device via the direct line.

### 1-1-1. Configuration for Supplying Power

Next, a configuration in which power is supplied from a battery 15 to a device that is each node of the communication system 1 will be described.

Each node (that is, the mobility computer 3, each zone ECU 5, and each terminal ECU 7) of the communication system 1 is configured to operate by receiving the supply of power from the battery 15, which is a power source, that is, a high-voltage battery (that is, an HV battery in the drawing) 15a or an auxiliary battery 15b.

The high-voltage battery 15a is a high-voltage (for example, several hundred volts) battery that can be used to a motor for driving the vehicle. A voltage of the high-voltage battery 15a is stepped down to a low voltage such as 12 V by a DCDC converter (that is, HV to LV DCDC in the drawing) 17 that steps down the voltage from a high voltage (that is, HV) to a low voltage (that is, LV), and is supplied to the first zone ECU 5a. The auxiliary battery 15b is also configured to supply power having a voltage of, for example, 12 V to the first zone ECU 5a.

### First Zone ECU

In the first zone ECU 5a, a power distribution line (PW DISTRIBUTION LINE) 21 is provided as a line for supplying power to each component in the first zone ECU 5a. Specifically, the power distribution line 21 is provided to supply the power, which is supplied from the DCDC converter 17 to the first zone ECU 5a, to each of IPDs 25a, 25b, and 25c, which are semiconductor relays, via an FET 23, which is a field effect transistor. On the power distribution line 21, a separation switch 27 capable of separating the power distribution line 21 thereof into an FET 23 and an FET 29 is provided. FET is an abbreviation for Field Effect Transistor, and IPD is an abbreviation for Intelligent Power Device.

The IPD is a semiconductor relay capable of connecting or disconnecting the power distribution line 21, that is, capable of supplying power (that is, ON) or cutting off power (that is, OFF). A well-known eFuse or the like can be adopted as the semiconductor relay.

The power distribution line 21 is configured to supply power from the auxiliary battery 15b to IPDs 25d, 25e, and 25f via the FET 29.

Further, a power distribution line 31 is provided to supply power from the first zone ECU 5a, specifically, from the IPD 25a, to the mobility computer 3. Similarly, a power distribution line 33 is provided to supply power from the IPD 25e to the mobility computer 3.

A power distribution line 35 is provided to supply power from the first zone ECU 5a, specifically, from the IPD 25b, to the second zone ECU 5b. Similarly, a power distribution line 37 is provided to supply power from the IPD 25f to the third zone ECU 5c.

A power distribution line 39 is provided to supply power from the first zone ECU 5a, specifically, from the IPD 25c, to the first terminal ECU 7a. Similarly, a power distribution line 41 is provided to supply power from the IPD 25d to the second terminal ECU 7b.

### Second Zone ECU

In the second zone ECU 5b, the power supplied from the first zone ECU 5a via the power distribution line 35 is supplied to each of IPDs 45a and 45b via a power distribution line 43 in the second zone ECU 5b.

A power distribution line 47 is provided to supply power from the second zone ECU 5b, specifically, from the IPD 45a, to the third terminal ECU 7c. Similarly, a power distribution line 49 is provided to supply power from the IPD 45b to the fourth terminal ECU 7d.

### Third Zone ECU

In the third zone ECU 5c, the power supplied from the first zone ECU 5a via the power distribution line 37 is supplied to each of IPDs 53a and 53b via a power distribution line 51 in the third zone ECU 5c.

A power distribution line 55 is provided to supply power from the third zone ECU 5c, specifically, from the IPD 53a, to the fifth terminal ECU 7e. Similarly, a power distribution line 57 is provided to supply power from the IPD 53b to the sixth terminal ECU 7f.

### 1-2. Configuration of Each Control Unit

Next, a main hardware configuration of each electronic control unit will be briefly described.

### Mobility Computer

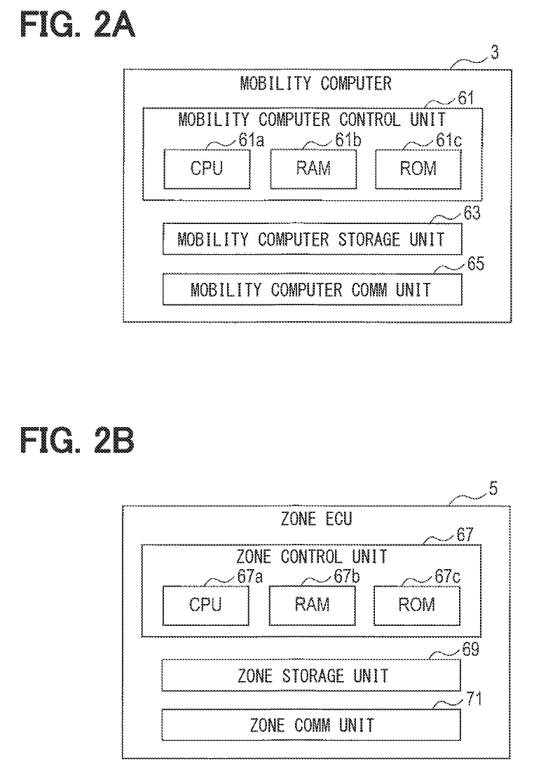

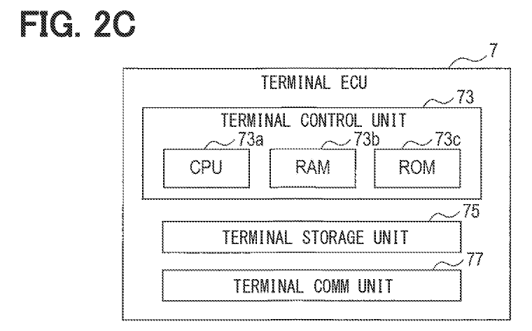

As illustrated in FIG. 2A, the mobility computer 3 is an electronic control unit that controls an overall operation of the communication system 1, and includes a mobility computer control unit 61, a mobility computer storage unit 63, and a mobility computer communication unit 65.

The mobility computer control unit 61 is a device that performs various calculation processing or the like related to an operation or the like of the mobility computer 3, and is mainly implemented by, for example, a microcomputer including a well-known CPU 61a, RAM 61b, ROM 61c, or the like.

Various functions of the mobility computer control unit 61 are implemented by the CPU 61a performing a program stored in a non-transitory tangible recording medium. In this example, for example, the ROM 61c corresponds to the non-transitory tangible recording medium storing the program. A method corresponding to the program is performed by performing the program.

The number of microcomputers constituting the mobility computer control unit 61 may be one or more. A method of implementing the various functions of the mobility computer control unit 61 is not limited to software, and some or all of elements may be implemented by using one or multiple pieces of hardware. For example, when the above functions are implemented by an electronic circuit that is hardware, the electronic circuit may be implemented by a digital circuit including many logic circuits, an analog circuit, or a combination thereof.

Examples of the mobility computer storage unit 63 include a well-known non-volatile memory. For example, a flash memory or an EEPROM capable of rewriting various types of data may be used. The mobility computer storage unit 63 stores control conditions for controlling supply of power to each terminal ECU 7 or the like. For example, in a case of a certain vehicle situation, control conditions such as a semiconductor relay to be turned off in order to stop power to a terminal ECU 7 or the like are stored as a management table.

The mobility computer communication unit 65 is a communication device capable of performing communication such as transmission and reception of data with each zone ECU 5 via each main communication line 11.

### Zone ECU

As illustrated in FIG. 2B, the zone ECU 5 is an electronic control unit that controls an operation of the zone ECU 5, and includes a zone control unit 67, a zone storage unit 69, and a zone communication unit 71.

The zone control unit 67 is a device that performs various calculation processing or the like related to an operation or the like of the zone ECU 5, and is mainly implemented by, for example, a microcomputer including a well-known CPU 67a, RAM 67b, ROM 67c, or the like.

Various functions of the zone control unit 67 are implemented by the CPU 67a performing a program stored in a non-transitory tangible recording medium. Since the zone control unit 67 is basically the same as the mobility computer control unit 61 or the like, the description thereof will be omitted.

Examples of the zone storage unit 69 include a well-known non-volatile memory. For example, a flash memory or an EEPROM capable of rewriting various types of data may be used. The zone storage unit 69 stores a control condition for controlling the supply of power to each terminal ECU 7 or the like when the communication in the main communication line 11 is interrupted as described later. For example, in a case of a certain vehicle situation, control conditions such as a semiconductor relay to be turned off in order to stop power to a terminal ECU 7 or the like are stored as a management table.

The zone communication unit 71 is a communication device capable of performing communication such as transmission and reception of data with the mobility computer 3 via each main communication line 11. The zone communication unit 71 is a communication device capable of performing communication such as transmission and reception of data with each terminal ECU 7 via the terminal communication line 13.

### Terminal ECU

As illustrated in FIG. 2C, the terminal ECU 7 is an electronic control unit that controls an operation of the terminal ECU 7, and includes a terminal control unit 73, a terminal storage unit 75, and a terminal communication unit 77.

The terminal control unit 73 is a device that performs various calculation processing or the like related to the operation or the like of the terminal ECU 7, and is mainly implemented by, for example, a microcomputer including a well-known CPU 73a, RAM 73b, ROM 73c, or the like.

Various functions of the terminal control unit 73 are implemented by the CPU 73a performing a program stored in a non-transitory tangible recording medium. Since the terminal control unit 73 is basically the same as the mobility computer control unit 61 or the like, the description thereof will be omitted.

Examples of the terminal storage unit 75 include a well-known non-volatile memory. For example, a flash memory or an EEPROM capable of rewriting various types of data may be used.

The terminal communication unit 77 is a communication device capable of performing communication such as transmission and reception of data with each zone ECU 5 via each terminal communication line 13.

### 1-3. Functional Configuration

Next, a functional configuration of the communication system 1 will be described.

### 1-3-1. Functional Configuration of Mobility Computer

Referring back to FIG. 1, the mobility computer 3 functionally includes a power supply management unit (PW SUPPLY MANAGEMENT UNIT) 81 and a communication and power supply cooperation control unit (COMM AND PW SUPPLY CONTROL UNIT) 83.

### Power Supply Management Unit

The power supply management unit 81 has a function of managing a state of an operation of the vehicle in functional units or units integrating multiple functions based on information (that is, a trigger) at the time of starting a predetermined function or a battery remaining amount. Examples of the battery remaining amount include a battery remaining amount of the high-voltage battery 15a and/or a battery remaining amount of the auxiliary battery 15b.

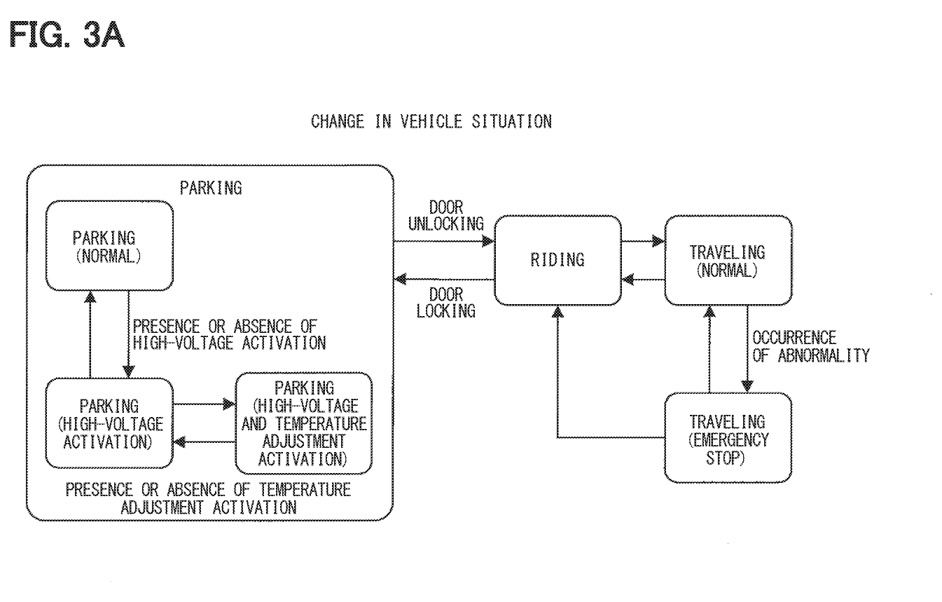

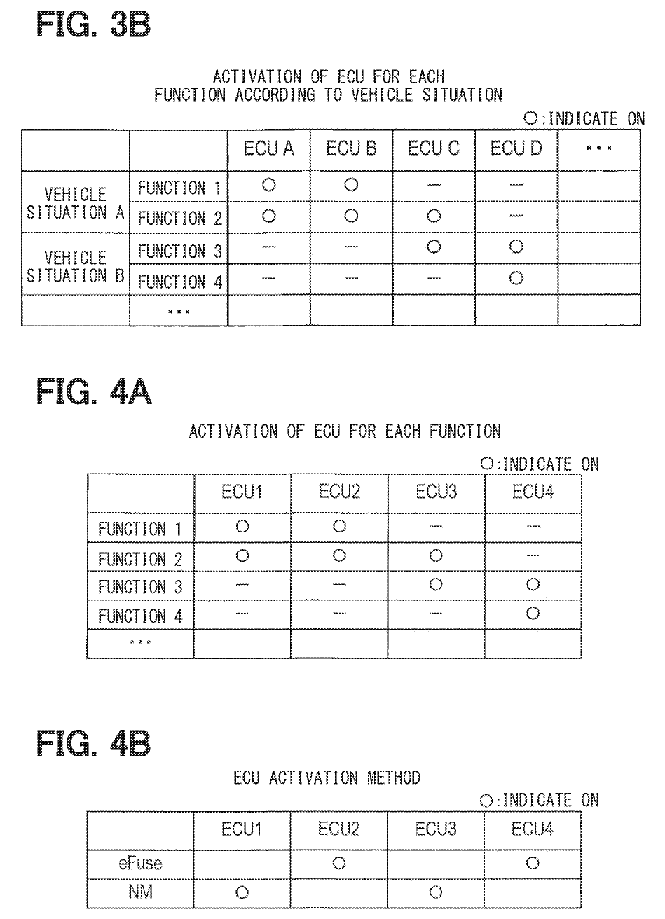

For example, as illustrated in FIG. 3A, the state of the operation of the vehicle (that is, the vehicle situation) includes parking (that is, parking with no occupant), riding (that is, stopping with an occupant), traveling (that is, normal traveling), emergency stop during traveling, or the like, which change according to various conditions.

For example, the parking and the riding change according to door unlocking, door locking, or the like. For example, when the vehicle is locked in a state in which there is no occupant, it can be determined that the state of the vehicle has shifted from riding to parking. On the other hand, when the vehicle is unlocked and the occupant is present, it can be determined that the vehicle has shifted from parking to riding.

The riding and the normal traveling change in a state in which a brake is depressed, for example, in a state in which a power switch or the like, which is a push switch, is operated. For example, when the power switch is operated in the state in which the brake is depressed, it can be determined that the state of the vehicle has shifted from riding to traveling. When an abnormality occurs during normal traveling, the state changes to a state of riding through a state of emergency stop. The power switch is a known switch for instructing the start or stop of an operation of an engine, a hybrid system, or the like of the vehicle.

Even during parking, there are parking at a normal state, parking at the time of high-voltage activation, and parking at the time of high-voltage and temperature adjustment activation, and these states also change according to the presence or absence of high-voltage activation, the presence or absence of temperature adjustment activation, or the like. The high-voltage activation is, for example, a process of activating a system monitoring mode or the like using the high-voltage battery 15a. The temperature adjustment activation is a process of activating a system for appropriately maintaining a temperature or the like in the vehicle.

As illustrated in FIG. 3B, an ECU (for example, a terminal ECU 7) to be operated is determined according to the vehicle situation, specifically, according to a function used in each vehicle situation, and thus each ECU is operated according to a necessary function. For example, a necessary ECU is set to a wakeup state. In FIG. 3B, the ECUs to be operated are indicated by circles.

The wakeup (that is, activation) is a normal activation state of the ECU, that is, a normal operation state in which the function of the ECU is not limited. The sleep (that is, stop) is a stop state of the ECU, that is, a state in which the function is limited as compared with the wakeup. The ECU can be switched to the wakeup state or the sleep state based on, for example, information included in an NM frame of a CAN frame. Power consumption of the ECU in the sleep state is smaller than that in the wakeup state. NM is an abbreviation for Network Management.

### Communication And Power Supply Cooperation Control Unit

The communication and power supply cooperation control unit 83 integrally manages power supply control by turning on or turning off a power supply of a load such as each ECU by a semiconductor relay, and control (that is, NM control) of wakeup and sleep of each ECU using, for example, an NM frame of a CAN frame.

That is, the communication and power supply cooperation control unit 83 performs cooperation control in consideration of a timing of an operation of the load such as each ECU.

For example, as illustrated in FIG. 4A, the communication and power supply cooperation control unit 83 manages ECUs to be activated (that is, powered on or waked up) in functional units. As illustrated in FIG. 4B, it is managed how to activate each ECU. FIG. 4B illustrates an ECU that is powered on by an eFuse and an ECU that is waked up by NW control. In the ECU, since normal power is supplied when the power supply is turned on and when the ECU is waked up, a normal operation (that is, an operation in which a function such as sleep is not limited) is possible.

### 1-3-2. Functional Configuration of Zone ECU

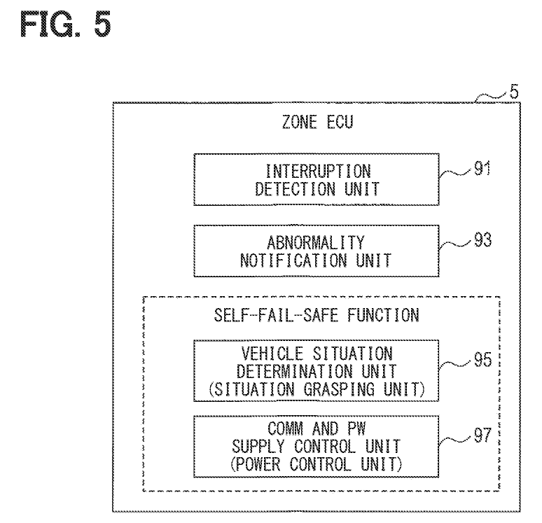

As illustrated in FIG. 5, each zone ECU 5 includes, as functional blocks, an interruption detection unit 91, an abnormality notification unit 93, a vehicle situation determination unit 95, and a communication and power supply cooperation control unit (COMM AND PW SUPPLY CONTROL UNIT) 97, as described later in detail. A self-fail-safe function for safely controlling the vehicle is exerted by the vehicle situation determination unit 95 and the communication and power supply cooperation control unit 97. The above-described functional blocks may be implemented in software manner by executing a program by at least one processor. The above-described functional blocks may also be implemented in hardware manner by executing the functions using a dedicated hardware circuit.

The interruption detection unit 91 is configured to detect an interruption of communication between each zone ECU 5 and the mobility computer 3 issuing the instruction of the power distribution control, that is, the interruption of communication in each main communication line 11. As is well known, the interruption of communication can be determined, for example, based on a fact that predetermined communication cannot be performed for a predetermined period.

When the interruption of communication with the mobility computer 3 is detected, the abnormality notification unit 93 notifies a user of the occurrence of the abnormality in vehicle communication or the power supply by using the interruption as a trigger, and announces the stopping of the vehicle.

The vehicle situation determination unit (that is, the situation grasping unit) 95 enters a self-fail-safe mode with the interruption of communication as a trigger. When the main communication line 11 is interrupted, the vehicle situation determination unit 95 acquires information for determining the vehicle situation (for example, various types of information obtained from an in-vehicle device such as a sensor) from communication with the terminal ECU 7 subordinated to the zone ECU 5 or communication with an electric device via a direct line. Based on the acquired information of the in-vehicle device, a vehicle situation is determined.

For example, information such as a vehicle speed, a shift position (that is, a position of a shift lever), and a battery remaining amount is acquired. Based on the information, for example, it is determined whether the vehicle is in a situation of riding in which the vehicle is stopped at a road shoulder or the vehicle is in a situation of parking.

The communication and power supply cooperation control unit (that is, the power control unit) 97 operates to replace a power supply management function of the mobility computer 3 that determines whether to issue an activation stop request (that is, a request to stop activation) according to the vehicle situation as described above.

For example, the power supply to the terminal ECU 7 unnecessary for the operation according to the vehicle situation is cut off or reduced, or when there are the multiple terminal ECUs 7 unnecessary for the operation, the power supply to the multiple terminal ECUs 7 is cut off or reduced in a stepwise manner. For example, power supply may be turned off by a semiconductor fuse, or power consumption may be reduced by causing the terminal ECU 7 to sleep.

The communication and power supply cooperation control unit 97 in each zone ECU 5 has a function of replacing the power supply management function of the communication and power supply cooperation control unit 83 of the mobility computer 3, but the power supply management functions of both may be the same. Alternatively, the communication and power supply cooperation control unit 97 of each zone ECU 5 may have a function simpler than the communication and power supply cooperation control unit 83 of the mobility computer 3.

For example, as the simplified function, it is possible to adopt a configuration in which the power supply to loads other than a minimum necessary load (that is, a minimum load for exerting a minimum necessary function set in advance) is turned off (that is, ALL OFF) when the vehicle situation is traveling, the speed is zero, the shift position is parking, and the battery remaining amount is equal to or less than a predetermined value. It is possible to set in advance which load is the minimum necessary load.

When the battery remaining amount is lower than the predetermined value, the terminal ECUs other than the minimum terminal ECU 7 set in advance may be powered off. Examples of the minimum terminal ECU 7 set in advance include a terminal ECU 7 capable of controlling lighting of a light, display of a meter, or the like, and a terminal ECU 7 used when the vehicle is started.

When the battery remaining amount of the high-voltage battery 15a is equal to or less than the predetermined value, a configuration for supplying power from the high-voltage battery 15a may be switched to a configuration for supplying power from the auxiliary battery 15b.

### 1-4. Basic Operation of Mobility Computer

Next, a basic operation of the mobility computer 3 will be described.

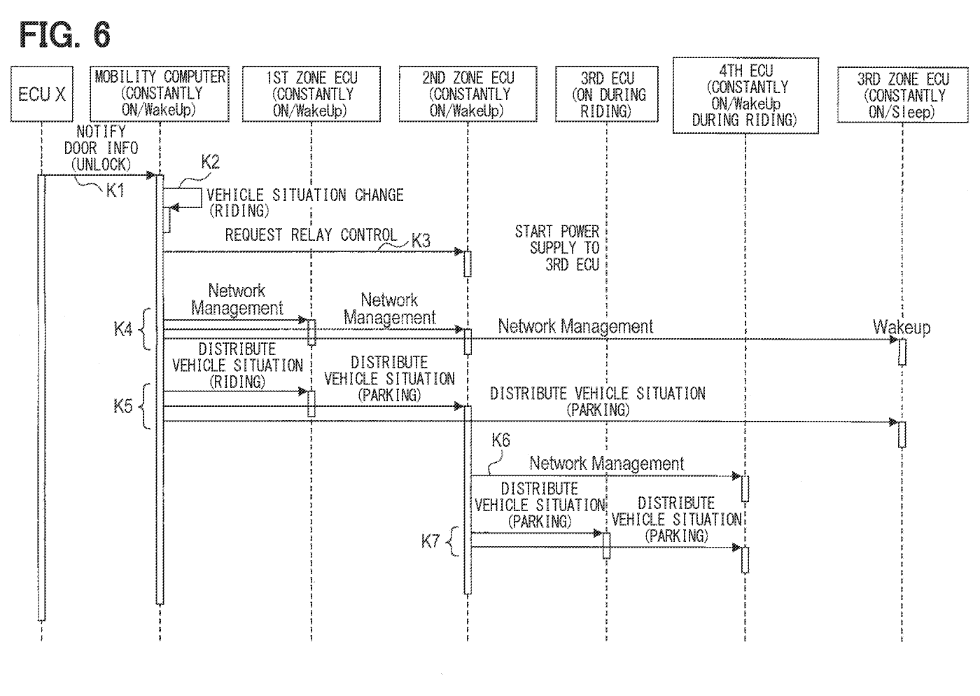

In FIG. 6, "constantly ON and WakeUp" indicates a wakeup state during constant energization. "ON during riding" indicates a constant energization state (that is, a wakeup state) during riding. "Constantly ON and WakeUp during riding" indicates a wakeup state during constant energization and riding. "Constantly ON and Sleep" indicates a sleep state during constant energization. The same applies to the other drawings. The energization means power supply (that is, power distribution) for supplying power.

ON-OFF control of energization to each zone ECU 5 and each terminal ECU 7 from the mobility computer 3 or NM control, in which a sleep or wakeup instruction using an NM frame of CAN is performed, will be described as an example.

### Operation when Changing from Parking to Riding: Basic Operation of Activation

As illustrated in FIG. 6, a certain terminal ECU 7 (for example, an ECU X) notifies the mobility computer 3 of door unlocking information (see step K1). Hereinafter, the steps will be omitted.

Next, in response to the notification of the door unlocking, the mobility computer 3 changes the vehicle situation to "riding" (see K2).

Next, a control signal for controlling the semiconductor relay is output from the mobility computer 3 to, for example, the second zone ECU 5b (see K3). Specifically, in order to energize a predetermined ECU (for example, the third terminal ECU 7c) to be operated during riding, a control signal for turning on the IPD 45a connected to the third terminal ECU 7c is output. Accordingly, the energization to the third terminal ECU 7c is started.

Next, by the NM control, the zone ECUs 5 (for example, the first to third zone ECUs 5a to 5c) to be operated during riding are waked up. For example, the NM frame is transmitted from the mobility computer 3 to each zone ECU 5 in order to wake up each zone ECU 5 (see K4).

Next, the vehicle situation indicating riding is distributed from the mobility computer 3 to the first to third zone ECUs 5a to 5c (see K5).

Next, the NM frame is transmitted from the second zone ECU 5b to the fourth terminal ECU 7d in order to wake up the fourth terminal ECU 7d (see K6).

Next, the vehicle situation indicating riding is distributed from the second zone ECU 5b to the third and fourth terminal ECUs 7c and 7d (see K7).

### Operation when Changing from Riding to Parking: Basic Operation of Stop

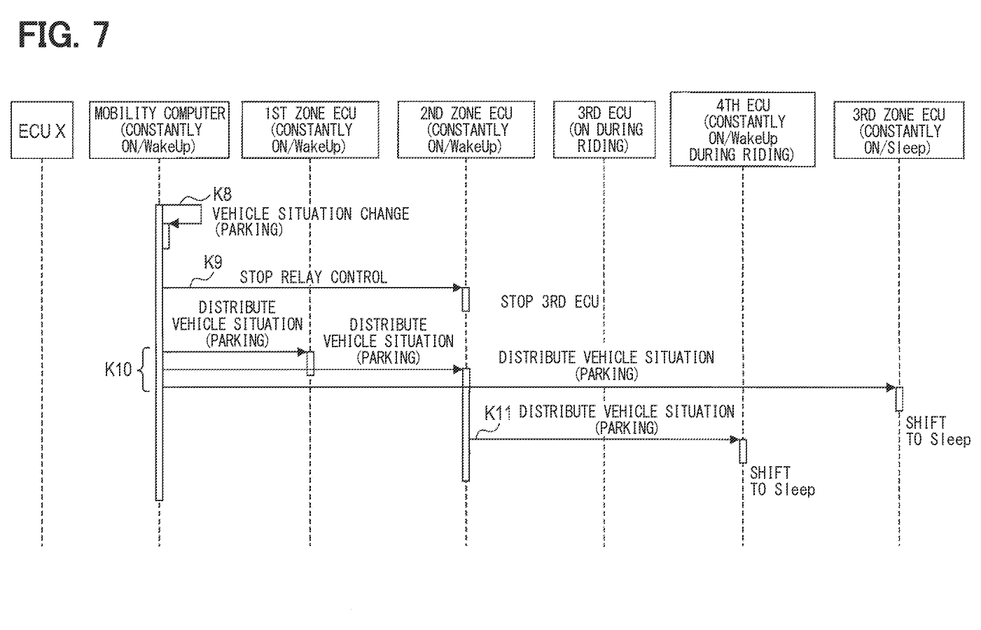

As illustrated in FIG. 7, when the state of the vehicle has shifted from riding to parking, the mobility computer 3 changes the vehicle situation to the parking (see K8).

Next, a control signal for controlling the semiconductor relay is output from the mobility computer 3 to, for example, the second zone ECU 5b (see K9). Specifically, in order to stop energization to a predetermined ECU (for example, the third terminal ECU 7c) to be operated during riding, a control signal for turning off the IPD 45a connected to the third terminal ECU 7c is output. Accordingly, for example, the energization to the third terminal ECU 7c is stopped.

Next, the vehicle situation indicating parking is distributed from the mobility computer 3 to the first to third zone ECUs 5a to 5c (see K10). Accordingly, for example, the third zone ECUs 5a to 5c shift to sleep.

Next, the vehicle situation indicating riding is distributed from the second zone ECU 5b to the fourth terminal ECU 7d (see K11). Accordingly, the fourth terminal ECU 7d shifts to sleep.

### 1-5. Operation when communication is interrupted

Next, an operation of the communication system 1 when communication is interrupted will be described.

In the first embodiment, when the main communication line 11 is interrupted, information of the vehicle (that is, vehicle information) is acquired from an in-vehicle sensor or the like by communication with the terminal ECU 7 subordinated to the zone ECU 5 or communication via a direct line, in order to determine the vehicle situation. Based on the acquired vehicle information, a vehicle situation is determined.

For example, information such as a vehicle speed, a shift position, and a battery remaining amount is acquired from a sensor or the like, and a vehicle situation (for example, a situation during riding or a situation during parking) is determined based on the information.

As described above, the zone ECU 5, in which the interruption of the main communication line 11 is detected, operates to replace the power supply management function of the mobility computer 3 that recognizes the vehicle situation and determines whether to issue an activation stop request (that is, a request to stop the activation) to the terminal ECU 7 or the like.

For example, when the vehicle is in a traveling state, when the vehicle speed is zero, the shift position is parking, and a condition in which the battery remaining amount is equal to or less than a predetermined value is satisfied, it is possible to perform control such as cutting off power supply to all the terminal ECUs 7 (that is, turning off all the power supplies: All OFF) except for the minimum necessary terminal ECU 7.

This will be specifically described below.

### Outline of Operation During Interruption

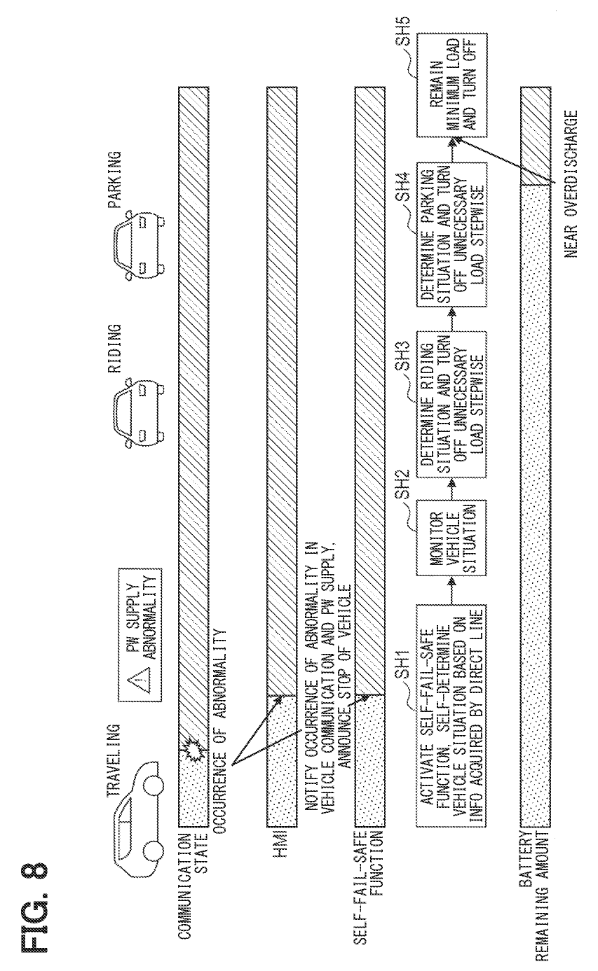

As illustrated in FIG. 8, a case where an abnormality occurs during traveling of the vehicle, for example, a case where an interruption of communication occurs in the main communication line 11 will be described.

When such an abnormality occurs, occurrence of a vehicle communication abnormality indicating an abnormality such as an interruption of communication in the vehicle or occurrence of a power supply abnormality is notified by the HMI 4. The power supply abnormality means that power supply control cannot be appropriately performed due to the vehicle communication abnormality.

When the abnormality due to the interruption of communication described above occurs, in the zone ECU 5 in which the interruption of communication is detected, the control by the function for safely operating the vehicle (that is, the self-fail-safe function) is performed.

Specifically, various types of information indicating the state of the vehicle are acquired from the terminal ECU 7 connected to the zone ECU 5, the sensor connected to the direct line, or the like. For example, information such as a vehicle speed and a shift position is acquired. Next, a current vehicle situation is grasped based on the acquired information. For example, a current vehicle situation (for example, a vehicle situation such as traveling or riding) is self-determined (see processing SH1). Hereinafter, the processing will be omitted.

Monitoring of such a vehicle situation is continuously performed (see SH2). For example, a vehicle situation or a change in the vehicle situation is grasped.

For example, when the vehicle shifts from traveling to riding, control is performed to turn off the power supply of the load that does not need to operate (for example, the terminal ECU 7 that does not need to operate among the multiple terminal ECUs 7) in the vehicle situation in a stepwise manner according to the vehicle situation (see SH3). For example, control is performed to stepwise decrease the terminal ECU 7 to be operated.

Thereafter, when the vehicle shifts from riding to parking, control is performed to turn off the power supply of the load that does not need to operate (for example, the terminal ECU 7 that does not need to operate among the multiple terminal ECUs 7) in the vehicle situation in a stepwise manner according to the vehicle situation (see SH4). For example, control is performed to stepwise decrease the terminal ECU 7 to be operated.

Thereafter, when the battery remaining amount is reduced to the predetermined value or less (for example, a state near over-discharge), the minimum necessary load (for example, the terminal ECU 7) is remained, and the power supply to all the loads is stopped (that is, all the power supplies are turned off: ALL OFF) (see SH5).

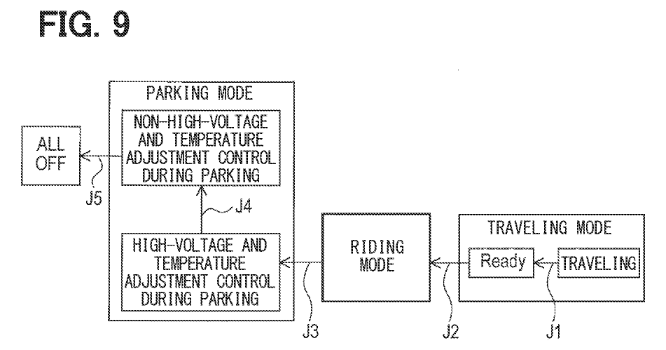

An example of a case where the power supply is turned off stepwise as described above will be described with reference to FIG. 9.

In a state in which it is determined that the vehicle is traveling (that is, a traveling mode), for example, power is supplied to all the loads (for example, all the terminal ECUs 7).

In the traveling mode, when the shift position is set to parking (that is, when a condition J1 is satisfied), the vehicle stands by as a preparation stage for shifting to another mode (that is, Ready state).

Next, in the Ready state, when the power switch is turned off (that is, when a condition J2 is satisfied), the vehicle shifts to a riding mode (that is, a mode indicating a state in which the vehicle is riding but not traveling). For example, energization to devices (that is, loads) related to a motor of a vehicle drive system and a motor of a wiper system is turned off. Specifically, energization to the terminal ECU 7 for controlling a motor and a wiper and energization to the motor of the vehicle drive system and the motor of the wiper system are turned off. During the above-described riding, a load for turning off the energization may be further increased based on operation information serving as various triggers.

Next, when the door is locked or when a seat sensor (that is, a seating sensor that detects seating) is turned off (that is, when a condition J3 is satisfied) during riding, it is determined that the occupant has gotten out of the vehicle, and the vehicle shifts to a parking mode. Specifically, for example, the vehicle shifts to a high-voltage and temperature adjustment mode during parking. Energization to devices (that is, loads) related to operations of a steering-by-wire, a seat, an airbag, a radar, a door, a mirror, and a power window is turned off. That is, the energization to the terminal ECU 7 for controlling each device described above and the energization to each device are turned off.

Next, in the high-voltage and temperature adjustment mode during parking, when the battery remaining amount is equal to or less than 20% of full charge (that is, when a condition J4 is satisfied), in order to further save power (that is, in a power saving mode), energization to devices (that is, loads) related to operations of a heat pump and a high-voltage battery system is turned off. Specifically, the energization to the terminal ECU 7 for controlling each device described above and the energization to each device are turned off.

When the battery remaining amount is equal to or less than 10% of full charge (that is, when a condition J5 is satisfied), energization to devices related to operations of headlights and taillights is turned off, and the energization to each zone ECU 5 is turned off. That is, the power supplies of all the loads are turned off (that is, All OFF) except for the minimum necessary load related to the operation of the vehicle.

### Specific Operation During Interruption

Next, a specific operation when communication is interrupted will be described in detail.

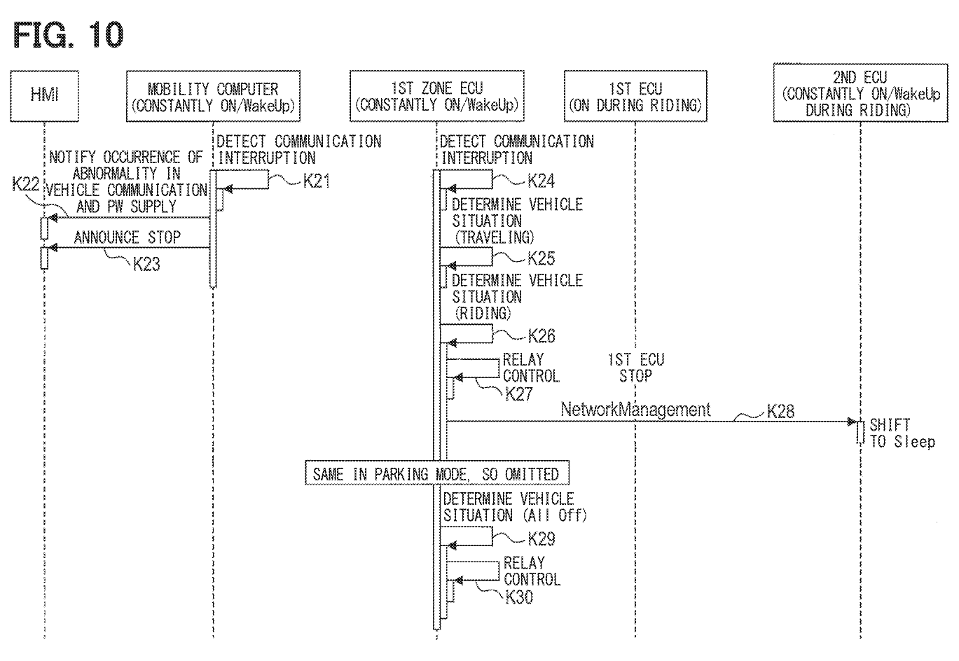

As illustrated in FIG. 10, the mobility computer 3 detects the interruption of communication of the main communication line 11 (see K21).

Next, the mobility computer 3 notifies the HMI 4 of the occurrence of the vehicle communication abnormality due to the interruption of communication or the occurrence of the power supply abnormality (see K22). That is, information for displaying, on the display, the occurrence of the vehicle communication abnormality or the occurrence of the power supply abnormality is transmitted to the HMI 4. Accordingly, in the HMI 4, for example, the occurrence of the vehicle communication abnormality or the occurrence of the power supply abnormality can be displayed on the display.

The mobility computer 3 notifies the HMI 4 of a stopping announcement as necessary (see K23). That is, for example, information for performing notification such as "a situation in which the vehicle is stopped because a vehicle communication abnormality has occurred" is transmitted to the HMI 4 by the speaker. Accordingly, in the HMI 4, the above-described notification to the user can be performed by the speaker.

In the first zone ECU 5a, the interruption of communication of the first main communication line 11a is detected (see K24).

Next, the vehicle situation is determined in the first zone ECU 5a (see K25). Accordingly, for example, in the case of traveling, it is determined that the vehicle is traveling.

Thereafter, the vehicle situation is further determined in the first zone ECU 5a (see K26). Accordingly, for example, when the vehicle is riding (that is, when the vehicle is not traveling but is riding), it is determined that the vehicle is riding.

In the first zone ECU 5a, relay control according to the vehicle situation is performed (see K27). For example, in order to stop energization to the first terminal ECU 7a to be operated during riding, a control signal for turning off the IPD 25c connected to the first terminal ECU 7a is output. Accordingly, the energization to the first terminal ECU 7a is stopped.

Next, an NM frame including information for causing an ECU of a data transmission destination to sleep is transmitted from the first zone ECU 5a to the second terminal ECU 7b (see K28). Accordingly, the second terminal ECU 7b shifts to sleep.

On the other hand, even when the vehicle situation is parking (that is, when the vehicle is stopped and there is no occupant), the processing of steps K26 to K28 or the like can be performed. In FIG. 10, the same steps are not described.

When the vehicle situation is determined, for example, when the battery remaining amount is equal to or less than 10%, it is determined that the vehicle situation is a situation in which the power supply is turned off (that is, a situation of ALL OFF) except for the minimum necessary load as described above (see K29).

Next, in order to turn off the power supply except for the minimum necessary load, relay control is performed to turn off the semiconductor relays connected to the loads except for the minimum necessary load (see K30).

### 1-6. Control Process when Communication is Interrupted

Next, a main part of control process performed in the zone ECU 5 when the communication is interrupted will be described.

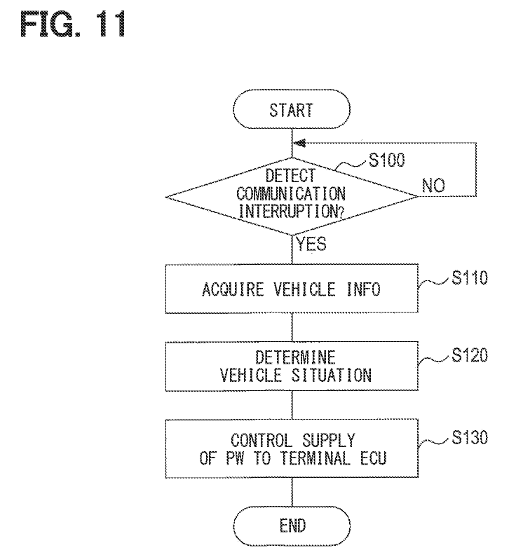

As illustrated in FIG. 11, the interruption detection unit 91 of each zone ECU 5 determines whether a communication interruption has occurred in the main communication line 11 connected to the zone ECU 5. When an affirmative determination is made, the processing proceeds to S110. On the other hand, when a negative determination is made, the processing waits.

In S110, since the communication interruption occurs, the vehicle situation determination unit 95 acquires, from the sensor or the like connected to the zone ECU 5 in which the communication interruption is detected, information (that is, vehicle information) indicating the state of the vehicle from various electric devices such as a sensor.

In subsequent S120, the vehicle situation determination unit 95 determines the vehicle situation based on the vehicle information detected by the sensor or the like. For example, as illustrated in FIG. 9, a situation such as traveling, riding, or stopping is determined.

In the subsequent S130, the communication and power supply cooperation control unit 97 controls a supply state of power to a load based on the determined vehicle situation.

As the control for the supply state of power to the load, for example, the communication and power supply cooperation control unit 97 may perform, according to the vehicle situation, relay control of turning off a semiconductor relay connected to the load in order to stop energization to the load such as the terminal ECU 7 or another electric device, which is connected to the zone ECU 5 in which the communication interruption is detected. The electronic control unit such as the terminal ECU 7 may be set to sleep instead of turning off the power supply.

When the communication is interrupted, the communication and power supply cooperation control unit 97 may stop energization to a load such as a predetermined terminal ECU 7 set in advance or another electric device, regardless of the vehicle situation. In this case, the electronic control unit such as the terminal ECU 7 may also be set to sleep instead of turning off the power supply.

Even when the communication is interrupted, the communication and power supply cooperation control unit 97 may continue the supply of power as usual without stopping the energization to the load such as the terminal ECU 7 or another electric device. Accordingly, when the battery remaining amount is sufficient or the like, a normal operation (that is, an operation without limitation such as a case of normal power-on or wakeup) is possible.

For example, when the first main communication line 11a is interrupted, the communication and power supply cooperation control unit 97 may continue to supply power to all terminal devices (for example, the first terminal ECU 7a and the second terminal ECU 7b) connected to the first zone ECU 5a.

Accordingly, in S130, when the communication and power supply cooperation control unit 97 completes the control for the supply state of power to the load, the present processing ends. The processing from S110 to S130 may be repeated to control the supply state of power in a stepwise manner.

### 1-7. Effects

According to the first embodiment, the following effects can be obtained.

(1a) In the first embodiment, it is possible to suitably secure safety when the vehicle operates (for example, when the vehicle is controlled) even when a failure occurs in communication (that is, communication is interrupted) between the mobility computer 3, which issues an instruction for power distribution control, and each zone ECU 5 that receives the instruction.

That is, when the interruption of communication between each zone ECU 5 and the mobility computer 3 is detected, each zone ECU 5 can control, according to the vehicle situation, the state of supplying power to each terminal ECU 7 or the like. Therefore, even when the communication between each zone ECU 5 and the mobility computer 3 is interrupted, the state of supplying power to each terminal ECU 7 or the like can be appropriately controlled by each zone ECU 5 according to the vehicle situation. Therefore, it is possible to suitably secure safety (that is, to implement proper fail-safe) when the vehicle operates. For example, it is possible to suitably control the operation of the vehicle during traveling. The vehicle situation indicates a type of the state of the operation of the vehicle, such as traveling, riding, or parking.

For example, when the communication between the first zone ECU 5a and the mobility computer 3 is interrupted, the first zone ECU 5a does not know how the mobility computer 3 controls the power supplied to the load (that is, the power supply state of the vehicle). In this case, it is conceivable that the first zone ECU 5a holds a previous value as a control value when the power is supplied to the load connected to the first zone ECU 5a, and continues the energization.

However, in such a case, since the first zone ECU 5a does not know the timing of turning off the power supplied to the load, the supply of power to all loads is continued. As a result, the power of the battery 15 may be consumed at an early stage (that is, early battery power shortage may occur). When the early battery power shortage occurs in this way, there is a possibility that a failure occurs in operations of various in-vehicle devices that operate by receiving the power from the battery 15, and the operation of the vehicle is adversely affected.

On the other hand, in the first embodiment, as described above, even when the communication between the first zone ECU 5a and the mobility computer 3 is interrupted, the state of supplying power to the load can be appropriately controlled according to the vehicle situation by the first zone ECU 5a, so that the early battery power shortage can be limited, and the load necessary for operating can be operated to improve the safety of the operation of the vehicle.

(1b) In the first embodiment, control conditions for controlling the supply of power to each terminal ECU 7 or the like are stored in the mobility computer 3 and each zone ECU 5. In particular, each zone ECU 5 stores control conditions such as a semiconductor relay to be turned off in order to stop power to a terminal ECU 7 or the like in a case of a certain vehicle situation when communication by the main communication line 11 is interrupted. Therefore, even when the communication by the main communication line 11 is interrupted and an instruction cannot be received from the mobility computer 3, the control for securing the safety of the vehicle can be performed in each zone ECU 5 by the control conditions.

(1c) In the first embodiment, when the interruption of communication is detected by the interruption detection unit 91, the vehicle situation can be grasped based on the information obtained from the sensor or the like connected to each zone ECU 5.

(1d) In the first embodiment, when the interruption of communication is detected by the interruption detection unit 91, for the loads such as the multiple terminal ECUs 7 that are control targets for controlling the power, a load such as the terminal ECU 7 that limits the supply of power can be increased in a stepwise manner (for example, a load for turning off the power supply can be gradually increased) according to the vehicle situation.

Accordingly, the load for turning off the power can be gradually increased according to the vehicle situation, so that a decrease in the battery remaining amount can be limited. For example, a decrease in the battery remaining amount can be limited by increasing the load for turning off the power supply as the battery remaining amount decreases. Accordingly, there is an advantage that safety when the vehicle is operated is improved by limiting a decrease in the battery remaining amount and securing a necessary battery remaining amount.

(1e) In the first embodiment, when the battery remaining amount is reduced to a predetermined value or less, the supply of power to a load other than the load, such as the minimum terminal ECU 7 set in advance required for the predetermined operation of the vehicle, is limited. Accordingly, consumption of the battery 15 can be reduced, and thus it is possible to avoid an undesirable situation in which the vehicle is not appropriately operated due to over-discharge of the battery 15.

(1f) In the first embodiment, when the interruption of communication is detected by the interruption detection unit 91, the user of the vehicle can be notified of the occurrence of the interruption of communication and/or the occurrence of the abnormality related to the supply state of the power due to the interruption of communication.

(1g) In the first embodiment, when the interruption of communication is detected by the interruption detection unit 91, a device (that is, an electric device) such as the terminal ECU 7 connected to the zone ECU 5 can be set to an energization state in which the supply of power is not limited (for example, a wakeup state in which the terminal ECU 7 is powered on). Accordingly, the electric device such as the terminal ECU 7 can operate as usual, and thus a normal operation and control can be performed.

(1h) In the first embodiment, when the interruption of communication is detected by the interruption detection unit 91, for the electric devices such as the multiple terminal ECUs 7 connected to each zone ECU 5, an electric device such as a predetermined terminal ECU 7 can be set to a state in which the supply of power is not limited or a state in which the supply of power is limited (for example, a power-off state or a sleep state) according to the vehicle situation.

Accordingly, consumption of the battery 15 can be reduced according to the vehicle situation, and thus it is possible to avoid a situation or the like in which the vehicle is not appropriately operated due to over-discharge of the battery 15. The state in which the supply of power is not limited means, for example, a state in which power is supplied such that only a predetermined limited number of electric devices (that is, the number of electric devices is smaller than that before the interruption of communication) can perform a normal operation.

(1i) In the first embodiment, when the interruption of communication is detected by the interruption detection unit 91, for the electric devices such as the multiple terminal ECUs 7 connected to each zone ECU 5, an electric device such as a predetermined terminal ECU 7 set in advance can be set to a state in which the supply of power is not limited or a state in which the supply of power is limited (for example, a power-off state or a sleep state).

Accordingly, consumption of the battery 15 can be reduced, and thus it is possible to avoid a situation in which the operation of the vehicle is adversely affected due to over-discharge of the battery 15. The state in which the supply of power is not limited means, for example, a state in which power is supplied such that only a predetermined limited number of electric devices (that is, the number of electric devices is smaller than that before the interruption of communication) can perform a normal operation.

(1j) In the first embodiment, when the interruption of communication is detected by the interruption detection unit 91, the terminal ECU 7 and other electric devices (that is, devices that operate by receiving the supply of power) are exemplified as devices that are targets for reducing the consumption of power.

(1k) In the first embodiment, when the interruption of communication is detected by the interruption detection unit 91, the communication and power supply cooperation control unit 97 can adopt, as a method of reducing the consumption of power, a method of cutting off energization to an electric device such as the terminal ECU 7 or a method of causing the terminal ECU 7 or the like to sleep.

### 1-8. Correspondence Relationship

Next, a relationship between the present disclosure and the first embodiment will be described.

The communication system corresponds to the communication system 1, the second electronic control unit corresponds to the mobility computer 3, the first electronic control unit corresponds to the zone ECU 5, the terminal device corresponds to the terminal ECU 7, the interruption detection unit corresponds to the interruption detection unit 91, the situation grasping unit corresponds to the vehicle situation determination unit 95, and the power control unit corresponds to the communication and power supply cooperation control unit 97.

### 2. Second Embodiment

Since a basic configuration of a second embodiment is the same as that of the first embodiment, differences from the first embodiment will be mainly described below. The same reference numerals as those in the first embodiment indicate the same configuration, and the preceding description will be referred to.

Since the second embodiment is different from the first embodiment in the configuration of the communication system, the difference will be mainly described.

The communication system of the second embodiment is based on a well-known domain architecture, and uses multiple electronic control units classified into multiple domains (that is, divided for each function).

### 2-1. Configuration for Performing Communication

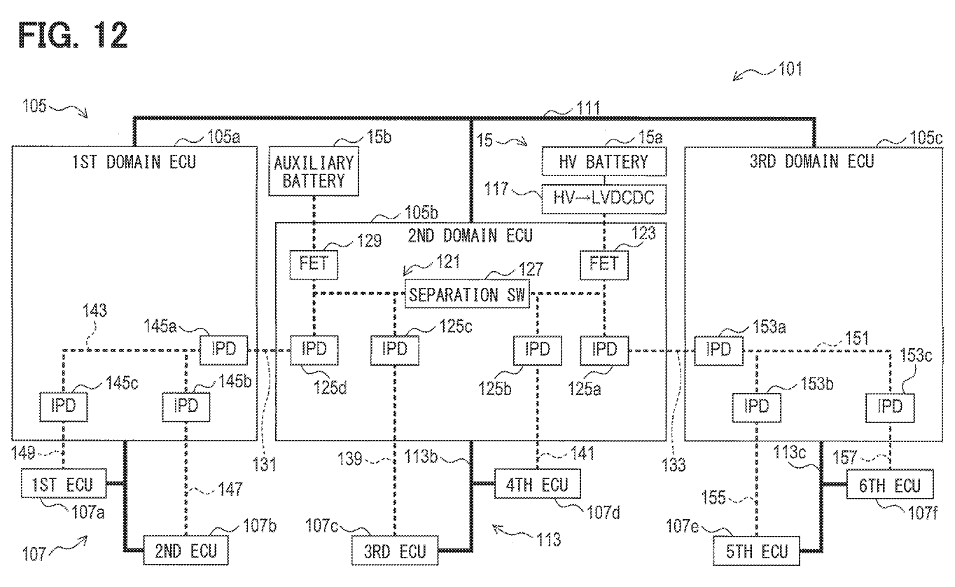

As illustrated in FIG. 12, a communication system 101 according to the second embodiment includes multiple domain ECUs 105 and multiple terminal ECUs 107 communicably connected to the domain ECUs 105.

Among the multiple domain ECUs 105, a first domain ECU 105a, a second domain ECU 105b, and a third domain ECU 105c are communicably connected to one another by a main communication line 111 similar to that of the first embodiment. In the second embodiment, the second domain ECU 105b is a management control unit that issues an instruction such as power distribution control.

Each domain ECU 105 is communicably connected to each terminal ECU 7 by a terminal communication line 113 similar to that of the first embodiment. Specifically, a first terminal ECU 107a and a second terminal ECU 107b are connected to the first domain ECU 105a by a first terminal communication line 113a. A third terminal ECU 107c and a fourth terminal ECU 107d are connected to the second domain ECU 105b by a second terminal communication line 113b. A fifth terminal ECU 107e and a sixth terminal ECU 107f are connected to the third domain ECU 105c by a third terminal communication line 113c.

### 2-2. Configuration for Supplying Power

Similarly to the first embodiment, the communication system 101 according to the second embodiment includes the high-voltage battery 15a and the auxiliary battery 15b as the battery 15.

The power of the high-voltage battery 15a is stepped down by a DCDC converter 117 and supplied to the second domain ECU 105b.

### Second Domain ECU

In the second domain ECU 105b, a power distribution line 121 is provided as a line for supplying power to each component in the second domain ECU 105b. Specifically, the power distribution line 121 is provided to supply the power, which is supplied from the DCDC converter 117 to the second domain ECU 105b, to each of IPDs 125a and 125b, which are semiconductor relays, via an FET 123. On the power distribution line 121, a separation switch 127 capable of separating the power distribution line 121 thereof into an FET 123 and an FET 129 is provided.

The power distribution line 121 is configured to supply power from the auxiliary battery 15b to IPDs 125c and 125d via the FET 129.

Further, a power distribution line 131 is provided to supply power from the second domain ECU 105b, specifically, from the IPD 125d, to the first domain ECU 105a. Similarly, a power distribution line 133 is provided to supply power from the IPD 125a to the third domain ECU 105c.

A power distribution line 139 is provided to supply power from the second domain ECU 105b, specifically, from the IPD 125c, to the third terminal ECU 107c. Similarly, the power distribution line 41 is provided to supply power from the IPD 125b to the fourth terminal ECU 107d.

### First Domain ECU

In the first domain ECU 105a, the power supplied from the second domain ECU 105b via the power distribution line 131 is supplied to each of IPDs 145a, 145b, and 145c via a power distribution line 143 in the first domain ECU 105a.

A power distribution line 147 is provided to supply power from the first domain ECU 105a, specifically, from the IPD 145b, to the second terminal ECU 107b. Similarly, a power distribution line 149 is provided to supply power from the IPD 145c to the first terminal ECU 107a.

### Third Domain ECU

In the third domain ECU 105c, the power supplied from the second domain ECU 105b via the power distribution line 133 is supplied to each of IPDs 153a, 153b, and 153c via a power distribution line 151 in the third domain ECU 105c.

A power distribution line 155 is provided to supply power from the third domain ECU 105c, specifically, from the IPD 153b, to the fifth terminal ECU 107e. Similarly, a power distribution line 157 is provided to supply power from the IPD 153c to the sixth terminal ECU 107f.

The second embodiment has the same effect as the first embodiment.

In the second embodiment, when communication is interrupted in the main communication line 111 between the second domain ECU 105b, which is a management control unit that issues an instruction such as power distribution control, and the first domain ECU 105a or the main communication line 111 between the second domain ECU 105b and the third domain ECU 105c, it is possible to perform control by the same self-fail-safe function as in the first embodiment.

That is, similarly to the first embodiment, by the self-fail-safe function of the first domain ECU 105a or the third domain ECU 105c, it is possible to perform appropriate control for securing safety with respect to a load (for example, each terminal ECU 107) connected to the first domain ECU 105a or the third domain ECU 105c. All the domain ECUs 105 have the self-fail-safe function.

### 3. Other Embodiments

Although the embodiments of the present disclosure are described above, it is needless to say that the present disclosure is not limited to the above-described embodiments and that various configurations can be adopted.

(3a) Among loads that operate by receiving power from a battery, examples of the load whose supply of power is controlled when communication of a main communication line is interrupted include various electric devices connected to a zone ECU.

For example, an electronic control unit such as a terminal ECU, and various electric devices (for example, a sensor or an actuator) other than the electronic control unit are exemplified. These electric devices may be directly connected to the zone ECU so as to be energized, or may be indirectly connected to the zone ECU via the terminal ECU so as to be energized. These electric devices may be directly and communicably connected to the zone ECU, or may be indirectly and communicably connected to the zone ECU via the terminal ECU.

(3b) Operations of the communication system described in the present disclosure may be implemented by a dedicated computer provided by forming a processor and a memory programmed to perform one or multiple functions embodied by a computer program.

Alternatively, the operations of the communication system described in the present disclosure may be implemented by a dedicated computer provided by forming a processor with one or more dedicated hardware logic circuits.

Alternatively, the operations of the communication system described in the present disclosure may be implemented by one or more dedicated computers implemented by a combination of a processor and a memory programmed to perform one or multiple functions, and a processor implemented by one or more hardware logic circuits.

The computer program may be stored in a computer-readable non-transitory tangible recording medium as an instruction to be performed by a computer. A method for implementing the functions of the communication system does not necessarily include software, and all the functions may be implemented using one or multiple pieces of hardware.

(3c) In addition to the communication system described above, the present disclosure can be implemented in various forms such as a configuration including the communication system as a component, a program for causing a computer of the communication system to function, a non-transitory tangible recording medium such as a semiconductor memory in which the program is recorded, and a method of controlling the communication system.

(3d) Multiple functions of one component in the above embodiments may be implemented by multiple components, and a function of one component may be implemented by multiple components. A plurality of functions of multiple components may be implemented by one component, or one function implemented by multiple components may be implemented by one component. A part of the configuration of each of the embodiments described above may be omitted. At least a part of the configuration of each of the embodiments described above may be added to or substituted for a configuration of another embodiment.

What is claimed is:

1. A communication system mounted on a vehicle, the communication system comprising:
one or more first electronic control units, each of the one or more first electronic control units being connected to one or more terminal devices and configured to control an operation of each of the one or more terminal devices; and
a second electronic control unit communicably connected to the one or more first electronic control units and configured to control an operation of each of the one or more first electronic control units,
wherein
the one or more terminal devices and the one or more first electronic control units are supplied with power from a power source,
a state of power supply to the one or more terminal devices and/or the one or more first electronic control units is controlled based on an instruction from the second electronic control unit, and
each of the first electronic control units includes at least one processor with a memory storing computer program, wherein the at least one processor with the memory is configured to:
detect an interruption of communication between the corresponding first electronic control unit and the second electronic control unit;
specify a vehicle situation indicating an operation state of the vehicle based on vehicle information, which is information obtained from an in-vehicle device, in response to detecting the interruption of communication; and
control the state of power supply to the one or more terminal devices according to the specified vehicle situation.

2. The communication system according to claim 1, wherein
the one or more first electronic control units and/or the second electronic control unit each stores a control condition for controlling the power supply to the one or more terminal devices.

3. The communication system according to claim 1, wherein,
in each of the one or more first electronic control units, the at least one processor with the memory is further configured to, in response to detecting the interruption of communication, specify the vehicle situation based on information acquired by the corresponding first electronic control unit.

4. The communication system according to claim 1, wherein
the one or more terminal devices to which the power supply is controlled by the one or more first electronic control units correspond to control target devices, and
in each of the one or more first electronic control units, the at least one processor with the memory is further configured to, in response to detecting the interruption of communication, increase a quantity of the control target devices to which the power supply is to be limited in a stepwise manner according to the specified vehicle situation.

5. The communication system according to claim 1, wherein,
when a battery remaining amount of the power source is decreased to a predetermined level or lower, in each of the one or more first electronic control units, the at least one processor with the memory is further configured to supply power to one of the one or more terminal devices, which is defined in advance as necessary for a predetermined operation of the vehicle, and limit the power supply to the remaining terminal devices.

6. The communication system according to claim 1, wherein,
in each of the one or more first electronic control units, the at least one processor with the memory is further configured to, in response to detecting the interruption of communication, notify a user of the vehicle about occurrence of the interruption of communication and/or occurrence of an abnormality related to the state of power supply caused by the interruption of communication.

7. The communication system according to claim 1, wherein,
in each of the one or more first electronic control units, the at least one processor with the memory is further configured to, in response to detecting the interruption of communication, set all of the terminal devices connected to the corresponding first electronic control unit to energization states without limitation in which power is supplied without limitation.

8. The communication system according to claim 1, wherein,
in each of the one or more first electronic control units, the at least one processor with the memory is further configured to, in response to detecting the interruption of communication, set, according to the specified vehicle situation, each of the one or more terminal devices connected to the corresponding first electronic control unit to (i) an energization state without limitation in which power is supplied without limitation or (ii) an energization state with limitation in which power is supplied with limitation.

9. The communication system according to claim 1, wherein,
in each of the one or more first electronic control units, the at least one processor with the memory is further configured to, in response to detecting the interruption of communication, set a predetermined terminal device, which is defined in advance among the one or more terminal devices, to (i) an energization state without limitation in which power is supplied without limitation or (ii) an energization state with limitation in which power is supplied with limitation.

10. The communication system according to claim 1, wherein
each of the one or more terminal devices is provided by an electronic control unit or an electric device other than the electronic control unit.

11. The communication system according to claim 10, wherein,
when each of the one or more first electronic control units reduces the power supply to the one or more terminal devices, the at least one processor with the memory in each of the one or more first electronic control units is further configured to (i) cut off the power supply to the one or more terminal devices or (ii) set each of the one or more terminal devices to a sleep state in which partial functions are limited.
